(19) United States
(12) Patent Application Publication
(10) Pub. No.: US 2006/0153954 A1
(43) Pub. Date: Jul. 13, 2006

(54) Enriched rice or enriched wheat

(75) Inventors: Toshihiro Ito, Yokkaichi-shi (JP); Noburu Sakaguchi, Yokkaichi-shi (JP); Tomohiko Kihira, Yokkaichi-shi (JP)

Correspondence Address: BIRCH STEWART KOLASCH & BIRCH, PO BOX 747, FALLS CHURCH, VA, 22040-0747, US

(73) Assignee: TAIYO KAGAKU CO., LTD., Mie (JP)

(21) Appl. No.: 10/542,200

(22) PCT Filed: Nov. 18, 2003
(86) PCT No.: PCT/JP03/14623

§ 371 Date: Jul. 15, 2005

(51) Int. Cl. A23L 1/00

(52) U.S. Cl. 426/302

(57) ABSTRACT

The present invention relates to enriched rice or barley characterized in that rice grains or barley grains are coated with an emulsifying agent-coated iron salt composition and vitamins, and further coated with a mixture of a hydrogenated oil and a polyglycerol fatty acid ester. The present invention also relates to enriched rice or enriched barley characterized in that rice grains or barley grains are coated with a mixture comprising an iron salt, a hydrogenated oil and a polyglycerol fatty acid ester. Further, the present invention relates to enriched rice or enriched barley characterized in that rice grains or barley grains are coated with a mixture comprising an emulsifying agent-coated iron salt composition, vitamins, a hydrogenated oil, and a polyglycerol fatty acid ester.

### TECHNICAL FIELD

The present invention relates to iron- and vitamin-enriched or iron-enriched, rice or barley.

### BACKGROUND ART

In a diet in Japan where rice has been a principal food, recently, wheat products such as bread have come to be taken as principal foods other than rice, and instant processed foods have come to be widely utilized. As a result, the diet has become nutritionally imbalanced, and the influence of the imbalance on human health has become a social concern. As a method of supplementing the imbalance as described above, inter alia, enriched polished rice or the like in which the surface of rice is enriched with vitamin B₁ and other water-soluble vitamins, fat-soluble vitamins and other nutrients which are likely to be deficient are made commercially available, and widely taken as food.

The enrichment as described above is made and provided, for example, by a method comprising macerating raw polished rice or raw polished barley in an acidic solution in which enrichment nutrients are dissolved, steam-boiling the rice or barley for a short time to include the nutrients, and subjecting the cooked rice or barley to hot-air drying; a method comprising emulsifying water-insoluble, fat-soluble nutrients, mixing water-soluble vitamins and mineral nutrients such as calcium and iron in proper amounts desired to be enriched to give an aqueous solution, or adding the water-soluble components to the emulsion, coating the surface of polished rice or the like with those nutrients by, for example, utilizing a fluidized granulator, a centrifugal fluidized coating granulator or the like, and drying the surface. However, a problem that a considerable amount of those nutrients adhered for enrichment is run off and lost in washing rice or the like with water before cooking has not been unavoidable. In order to prevent the problem, in a case other than the processing as “musenmai” (wash-free rice, rice which does not need washing with water before cooking), it is desired that the adhered nutrients are fixed to rice or the like so as not to easily migrate to an aqueous phase while washing with water. However, an effective coating method for practical use has not yet been found at present. In addition, since a method of coating with zein or shellac necessitates large-scaled manufacturing facilities, those methods have not so far been adopted industrially.

A method of coating with an emulsion of a fat or oil and a wax described in JP-B-Hei-5-30426 (JP-A-Showa-59-130157) has a problem of lowering in flavor because of the use of the wax.

In addition, the method using ethanol described in JP-A-Hei-8-56593 has some problems, for example, that only those soluble in ethanol can be used as coating agents, and there is a risk that ethanol used in the coating may ignite fire.

Furthermore, there is a problem that lowering in activities of vitamins takes place early in the presence of an iron salt, so that it is difficult to stably enrich with iron and vitamins at the same time. Therefore, the countermeasure for this problem has not so far been drawn up.

### DISCLOSURE OF INVENTION

An object of the present invention is to provide stable enriched rice or enriched barley capable of being manufactured industrially safely, in which run-off of iron or the like adhered to the surface of rice grains or barley grains when washing rice in an ordinary manner (washing rice with water), and lowering in the activity of the vitamins caused by iron when iron and vitamins are adhered at the same time are suppressed.

Another object of the present invention is to provide stable enriched rice or enriched barley, which is industrially safe, and capable of being manufactured easily in a single coating step, in which run-off of iron and the like adhered to the surfaces of rice grains or barley grains is reduced when washing rice in an ordinary manner (washing with water).

In a first embodiment, the present invention provides stable enriched rice or enriched barley capable of being manufactured industrially safely, in which rice grains or barley grains are coated with an emulsifying agent-coated iron salt composition and vitamins, and further coated with a mixture of a hydrogenated oil and a polyglycerol fatty acid ester, whereby run-off of iron and vitamins adhered to the surface of the rice grains or barley grains and lowering of activities of vitamins caused by iron are suppressed.

In a second embodiment, the present invention provides stable enriched rice or enriched barley, which is industrially safe, and capable of being manufactured easily in a single coating step, in which rice grains or barley grains are coated with a mixture comprising an iron salt, a hydrogenated oil and a polyglycerol fatty acid ester, whereby run-off of iron when the rice is washed is suppressed.

In a third embodiment, the present invention provides stable enriched rice or enriched barley, which is industrially safe, and capable of being manufactured easily in a single coating step, in which rice grains or barley grains are coated with a mixture comprising an emulsifying agent-coated iron salt composition, vitamins, a hydrogenated oil and a polyglycerol fatty acid ester, whereby run-off of iron and vitamins adhered to the surface of rice grains or barley grains when rice is washed and lowering of activities of vitamins by iron are suppressed.

### BEST MODE FOR CARRYING OUT THE INVENTION

First, the first embodiment will be explained.

The rice in this embodiment is not limited by its kind, and may be any of nonglutinous rice, glutinous rice, upland rice, indica type rice, javanica type rice and the like. The rice in this embodiment is not limited by the degree of polishing, and can be any of polished rice, polished rice with embryo, 70% bran-polished rice (nanabuzukimai), 50% bran-polished rice (gobuzukimai), unpolished rice and the like.

The barley in this embodiment is not limited by its kind, and may be any of barley, bread wheat, club wheat, durum wheat, adlay, oats, rye and the like. The barley in this embodiment is not limited by the degree of polishing or the shape, and may be any of pressed barley, bisected milled barley, rice grain-like barley and the like.

The iron salt in this embodiment is not particularly limited, and refers to ferric pyrophosphate, ferric citrate, ferrous sodium citrate, ferrous sulfate, ferric gluconate, iron lactate, ferric hydroxide, ferric chloride, ferrous fumarate, iron sesquioxide, iron threonine or the like. These iron salts can be used alone or in combination of plural kinds. From the viewpoint of suppressing run-off of iron when washing rice, an iron salt insoluble in water, such as ferric pyrophosphate, ferrous fumarate, or iron threonine is preferable, and also in consideration of color tone and flavor, ferric pyrophosphate is most preferable. Here, the term insoluble refers to those that are “very difficult to dissolve” (the amount of water necessary for dissolving 1 g of a solute is 1,000 ml or more and less than 10,000 ml) or “hardly soluble” (the amount of water necessary for dissolving 1 g of a solute is 10,000 ml or more) according to the test method of the Japanese Standards of Food Additives 7th Ed., General Provision 29, and the term preferably corresponds to those that are “hardly soluble.”

The emulsifying agent-coated iron salt composition in this embodiment is not particularly limited, as long as the iron salt is coated with an emulsifying agent. The emulsifying agent usable for coating is not particularly limited, and a general emulsifying agent for food, for example, a sucrose fatty acid ester, a glycerol fatty acid ester, a propylene glycol fatty acid ester, a sorbitan fatty acid ester, an enzymatically decomposed lecithin or the like can be used alone or in combination of plural kinds. It is desired to use an enzymatically decomposed lecithin having high coating effect.

The enzymatically decomposed lecithin in this embodiment is not particularly limited, as long as it is a product obtained by hydrolyzing lecithin with a phospholipase or the like. As for the raw material lecithin, any of a plant-derived lecithin such as soybean and an animal-derived lecithin such as an egg yolk can be used. As for the phospholipase, any of phospholipases can be used as long as the phospholipase possesses a phospholipase A and/or D activity, regardless of the origin, such as those originated from an animal such as pig pancreas, those originated from a plant such as cabbage, and those originated from a microbe such as mold. The phospholipase A, which is an enzyme hydrolyzing a fatty acid ester on 1- or 2-position of diacyl glycerophospholipid, is preferable, and phospholipase A₂ hydrolyzing 2-position of diacyl glycerophospholipid is more preferable.

When coating the iron salt, although a satisfactory effect is obtained with single use of the enzymatically decomposed lecithin, it is preferable to use the enzymatically decomposed lecithin together with other surfactant components such as an emulsifying agent for foods, such as a sucrose fatty acid ester, a glycerol fatty acid ester, a propylene glycol fatty acid ester, or a sorbitan fatty acid ester, a saponin compound originated from quillaia or Yucca foam is more preferable because the dispersibility of an iron salt in a coating liquid used for coating rice grains or barley grains is improved, whereby the iron salt can be coated more homogeneously. Especially, the nonionic detergent is more preferable because systemic absorbability of the iron salt is also enhanced.

The above-mentioned nonionic detergent includes, but not particularly limited to, for example, a polyglycerol fatty acid ester, a sucrose fatty acid ester, a glycerol fatty acid ester, a propylene glycol fatty acid ester, a sorbitan fatty acid ester, a pentaerythritol fatty acid ester, a sorbitol fatty acid ester and the like. Among them, the polyglycerol fatty acid ester is preferable. The polyglycerol fatty acid ester as used herein is an ester formed between a polyglycerol and a fatty acid, and the average degree of polymerization, the kind of the fatty acid and the degree of esterification of the polyglycerol constituting the ester are not particularly limited. The polyglycerol constituting the polyglycerol fatty acid ester has an average degree of polymerization of preferably 3 or more, more preferably from 3 to 11. The fatty acid constituting the polyglycerol fatty acid ester has preferably from 6 to 22 carbon atoms, more preferably from 8 to 18 carbon atoms, most preferably from 12 to 14 carbon atoms. The fatty acid can be any of those saturated or unsaturated, or those which have hydroxyl group on linear or branched chain.

Moreover, the methods for coating an iron salt with an emulsifying agent includes, but not particularly limited to, for example, a method comprising carrying out neutralization and salt-formation reaction in a solution in which an emulsifying agent is dissolved to give a precipitate, subjecting the mixture to a liquid-solid separation; a method comprising mixing an iron salt and a solution prepared by dissolving an emulsifying agent in a solvent capable of dissolving the emulsifying agent such as water, and removing the solvent by means of spray-drying, lyophilization or the like; a method comprising previously heating an emulsifying agent to melt, mixing an iron salt therewith, and thereafter cooling the mixture to solidify. In addition, when the emulsifying agent is in the form of a liquid at room temperature, a method comprising mixing an iron salt homogeneously as it is can be also employed.

Among them, the method utilizing neutralization and salt-formation described in WO 98/14072 is most preferable because the particle size of the emulsifying agent-coated iron salt composition can be controlled to be small, and more homogeneous coating can be achieved when rice grains or barley grains are coated.

For example, in the case of an emulsifying agent-coated ferric pyrophosphate composition, the emulsifying agent-coated ferric pyrophosphate composition can be obtained in a solid phase portion by adding an iron solution prepared by dissolving ferric chloride hexahydrate and enzymatically decomposed lecithin gradually to a pyrophosphate solution prepared by dissolving tetrasodium pyrophosphate decahydrate and pentaglycerol monomyristate with stirring, forming a salt by neutralization reaction, and thereafter subjecting the mixture to a liquid-solid separation.

The emulsifying agent-coated iron salt composition in this embodiment has an average particle size as determined by laser diffraction particle size distribution of preferably 2 μm or less, more preferably from 0.05 to 2 μm. Methods for obtaining an average particle size of this range are not particularly limited. For example, in the case of the above-mentioned method utilizing neutralization and salt-formation, the method includes a method comprising adjusting mixing rates of both the solutions, thereby adjusting the salt-formation reaction rate; in the case of the method in which other powder form iron salt is used as a raw material, the method includes a method comprising pulverizing the iron salt with a pulverizer such as Cobol Mill in an emulsifying agent solution. In the case where those having particle sizes not exceeding 2 μm are utilized, excellent dispersibility of the iron salt in a coating liquid is obtained when the rice grains or barley grains are coated, so that even more homogeneous coating is achieved when rice grains or barley grains are coated.

The iron content in solid content of the emulsifying agent-coated iron salt composition is preferably from 1 to 15% by weight, more preferably from 5 to 10% by weight.

The vitamins in this embodiment are not particularly limited as long as these are generally referred to as vitamins. The vitamins include vitamin A, vitamin B₁, vitamin B₂, vitamin B₆, vitamin B₁₂, vitamin C, vitamin D, vitamin E, niacin (nicotinic acid), pantothenic acid, folic acid and the like.

As to the iron salt and vitamins, the kinds of nutrients and each of the amounts can be properly selectively adhered and enriched depending upon the desired enrichment. For example, vitamin B₁ can be added in reference to the standard amount of Japanese special nutritive foods so as to have a concentration of from 100 to 150 mg per 100 g of rice. In addition, vitamin B₁ can be enriched so as to supplement the deficiency in reference to the results of the national nutrition survey in Japan. Alternatively, the nutritional level of rice or the like can be enhanced in agreement to that of the original unpolished rice or the like.

Also, one or more kinds of essential amino acids such as lysine, threonine, tryptophan, minerals other than iron such as calcium and magnesium, compounds contributing to human wellness such as α-linolenic acid, EPA, DHA, evening primrose oil, octacosanol, casein phosphopeptide (CPP), casein calcium peptide (CCP), dietary fiber, oligosaccharide, and other useful compounds approved as food additives can be added at the same time.

The hydrogenated oil in this embodiment is not particularly limited as long as the hydrogenated oil does not melt at an ordinary temperature. Usually, the hydrogenated oil is an fat or oil having a melting point of 40° C. or higher, and includes vegetable hydrogenated oils such as soybean hydrogenated oil, cottonseed hydrogenated oil, rapeseed hydrogenated oil, rice hydrogenated oil, and Indian corn hydrogenated oil; animal fats and oils such as beef tallow and lard; and animal hydrogenated oils obtained by hydrogenation of animal fats and oils. From the viewpoint of influence on taste or the like, the vegetable hydrogenated oil is preferable.

The polyglycerol fatty acid ester used together with the hydrogenated oil in this embodiment is an ester formed between a polyglycerol and a fatty acid, and the average degree of polymerization of the polyglycerol constituting this ester, the kinds of the fatty acid, and the esterification ratio are not particularly limited. The polyglycerol constituting the polyglycerol fatty acid ester has an average degree of polymerization of preferably 3 or more, more preferably from 3 to 11. The fatty acid constituting the polyglycerol fatty acid ester is preferably a fatty acid having hydroxyl groups on saturated or unsaturated straight or branched chain having 8 to 20 carbon atoms or condensed ricinoleic acid.

Specifically, one or more kinds selected from hexaglycerol hexastearate, hexaglycerol octastearate, hexaglycerol condensed ricinoleate, pentaglycerol condensed ricinoleate are preferable, and combined use of one or more kinds selected from hexaglycerol hexastearate and hexaglycerol octastearate and one or more kinds selected from hexaglycerol condensed ricinoleate and pentaglycerol condensed ricinoleate are more preferable.

The amount of the polyglycerol fatty acid ester added to the hydrogenated oil is not particularly limited. The amount of the polyglycerol fatty acid ester is preferably from 0.5 to 20 parts by weight, more preferably 0.5 to 10 parts by weight, based on 100 parts by weight of the hydrogenated oil. It is preferable that the amount of the polyglycerol fatty acid ester is within this range, because homogeneous coating can be achieved on the surface of rice or barley, and the coating is less likely to be peeled off, so that enriched iron and vitamins are less likely to run off.

In the method for producing the enriched rice or enriched barley of this embodiment, rice grains or barley grains can be first coated with an emulsifying agent-coated iron salt composition and vitamins, and thereafter further coated with a mixture of the hydrogenated oil and a polyglycerol fatty acid ester.

In this embodiment, the method of coating rice grains or barley grains with an emulsifying agent-coated iron salt composition and vitamins is not particularly limited, as long as the rice grains or barley grains can be homogeneously coated, and a conventionally employed method can be utilized except that the emulsifying agent-coated iron salt composition is used as an iron salt. The method includes, for example, a method comprising placing rice or barley in a rotating coating pan, and spraying a solution prepared by dispersing the emulsifying agent-coated iron salt composition and vitamins in water or the like onto the rice or barley to coat; a method comprising carrying out the same procedures in a fluidized granulator with supplying hot air; a method comprising allowing rice or barley to swell in a solution prepared by dispersing the emulsifying agent-coated iron salt composition and vitamins in water or the like to absorb the iron salt and the vitamins in the rice or barley, and drying the product. Especially, a method utilizing spray-coating having a small degree of pyrolysis of vitamins due to heat is preferable, because an even more homogeneous coating can be provided.

It is preferable to add a polyglycerol fatty acid ester to the solution for dispersing the emulsifying agent-coated iron salt composition and vitamins because the dispersibility of the emulsifying agent-coated iron salt composition and fat-soluble vitamins becomes excellent. In this case, the polyglycerol fatty acid ester can be used for the purpose of emulsifying fat-soluble vitamins and the like.

Here, when further enriched with nutrients other than iron and vitamins, rice or barley can be coated with a mixture of further nutrients together with the emulsifying agent-coated iron salt composition and vitamins in this coating solution.

In this embodiment, the method of coating iron- and vitamin-coated rice grains or barley grains with a mixture of a hydrogenated oil and a polyglycerol fatty acid ester is not particularly limited, and conventionally employed methods except that a mixture of a hydrogenated oil and a polyglycerol fatty acid ester can be utilized. The method includes, for example, a method comprising placing iron- and vitamin-coated rice or barley in a coating pan, and spraying a hydrogenated oil in which a polyglycerol fatty acid ester is dissolved at an ordinary temperature or with blowing hot air therein to coat; and a method comprising carrying out the same procedures in a fluidized granulator. Among them, a method utilizing spray-coating which is capable of even more homogeneous coating is preferable.

A pigment such as vitamin B₂, β-carotene, or crocin pigment may be added to this coating solution for the purpose of coloring the final enriched rice or enriched barley.

The preferred composition of the enriched rice or enriched barley of this embodiment is 5 to 10 parts by weight of the emulsifying agent-coated iron salt composition, 0.1 to 2 parts by weight of vitamins, 1 to 8 parts by weight of the hydrogenated oil and 0.1 to 5 parts by weight of the polyglycerol fatty acid ester based on 100 parts by weight of rice grains or barley grains.

Next, the second embodiment will be explained.

In this embodiment, rice, barley, and an iron salt refers to the same ones as those in the first embodiment. However, the iron salt used in this embodiment is an iron salt itself without being coated with an emulsifying agent. The average particle size of the iron salt is not particularly limited, and the average particle diameter as determined by laser diffraction type particle size distribution is preferably 2 μm or less, more preferably 1 μm or less, most preferably 0.5 μm or less. The lower limit of the average particle diameter is about 0.05 μm. When the average particle size is 2 μm or less, more homogeneous coating can be accomplished when rice grains or barley grains are coated. A method for obtaining an iron salt of this average particle size include a method according to neutralization and salt-formation (WO 98/14072), a method of pulverizing an iron salt with a dry-type pulverizer such as a jet mill, or a wet-type pulverizer such as Cobol Mill and Dyno-Mill. A method of pulverizing an iron salt with a wet-type pulverizer in a polyglycerol fatty acid ester and a hydrogenated oil is preferable, because pulverization and homogenous mixing-and-dispersion can be accomplished at the same time.

In this embodiment, the polyglycerol fatty acid ester refers to the same one as that used together with the hydrogenated oil in the first embodiment. The polyglycerol fatty acid ester suitable for this embodiment has an HLB calculated from a ratio of the molecular weights of hydrophilic groups and lipophilic groups of preferably 5 or less, more preferably 4 or less.

In addition, in this embodiment, an emulsifying agent for foods other than the polyglycerol fatty acid ester can be used together. The emulsifying agent for foods includes, for example, a sucrose fatty acid ester, a glycerol fatty acid ester, a propylene glycol fatty acid ester, a sorbitan fatty acid ester, lecithin, enzymatically decomposed lecithin, and the like.

In this embodiment, the hydrogenated oil includes those exemplified in the first embodiment. The hydrogenated oil suitable for this embodiment is usually an oil having a melting point of 30° C. or higher, and an oil having a melting point of 35° C. or higher is preferable.

The amount of the iron salt is not particularly limited, and can be adjusted depending on the kinds of the iron salt according to the desired ratio of enrichment. The iron salt can be formulated in an amount of usually from 1 to 100 parts by weight, based on 100 parts by weight of the hydrogenated oil. The lower limit of the amount of the iron salt is preferably 10 parts by weight, more preferably 25 parts by weight based on 100 parts by weight of the hydrogenated oil. When the amount of the iron salt is 1 part by weight or more, it is practical because a large amount of the mixture would not be necessary for enrichment with iron. The upper limit of the amount of the iron salt is preferably 90 parts by weight, more preferably 75 parts by weight based on 100 parts by weight of the hydrogenated oil. When the amount of the iron salt is 100 parts by weight or less, the coating of the iron salt with the hydrogenated oil is satisfactory, so that the iron salt will be prevented from being run-off while washing rice with water.

The amount of the polyglycerol fatty acid ester is not particularly limited, and the polyglycerol fatty acid ester can be formulated in an amount of from 0.1 to 100 parts by weight based on 100 parts by weight of the hydrogenated oil. The lower limit of the amount of the polyglycerol fatty acid ester is preferably 1 part by weight, more preferably 5 parts by weight based on 100 parts by weight of the hydrogenated oil. When the amount of the polyglycerol fatty acid ester is 0.1 parts by weight or more, it is practical because the iron salt can be sufficiently dispersed. The upper limit of the amount of the polyglycerol fatty acid ester is preferably 50 parts by weight, more preferably 20 parts by weight based on 100 parts by weight of the hydrogenated oil. When the amount of the polyglycerol fatty acid ester is 100 parts by weight or less, run-off of the components incorporated by emulsification phase inversion is less likely to take place while washing rice with water.

In this embodiment, the material for enrichment of rice or barley is not limited to iron alone, and other materials described in the first embodiment which would not cause lowering of the activity by iron can be used for enrichment.

The amount of these materials is such that the kinds of nutrients and the amount of each nutrient are selectively adhered for enrichment according to desired enrichment. These materials can be mixed with the polyglycerol fatty acid ester and the hydrogenated oil at the same time as the iron salt, and the rice grains or barley grains may be coated with the mixture.

Among them, an oil-soluble material may be dissolved in a hydrogenated oil. As to an oil-insoluble material, it is desired to pulverize the material in the same manner as the iron salt so as to have an average particle size as determined by laser diffraction particle size distribution of preferably 2 μm or less, more preferably 1 μm or less, most preferably 0.5 μm or less, because more homogeneous coating can be accomplished when rice grains or barley grains are coated. As in the case with the above-mentioned iron salt, this pulverization may be preferably carried out by a method of pulverization with a wet-type pulverizer, and pulverization can be carried out with a pulverizer at the same time as the iron salt.

In the method for producing the enriched rice or barley of this embodiment, a mixture comprising an iron salt, a hydrogenated oil and a polyglycerol fatty acid ester can coat rice grains or barley grains. A mixture comprising an iron salt, a hydrogenated oil and a polyglycerol fatty acid ester can be then used directly, or used as an emulsion prepared by emulsifying the mixture in water. Direct use is preferable since a step such as drying is not required.

In this embodiment, the method for coating rice grains or barley grains with a mixture comprising an iron salt, a hydrogenated oil and a polyglycerol fatty acid ester is not particularly limited as long as homogeneous coating can be accomplished on rice grains or barley grains. The method includes, for example, a method comprising placing rice or barley in a rotating coating pan, and spray-coating a mixture comprising an iron salt, a hydrogenated oil and a polyglycerol fatty acid ester to the rice or barley, with blowing hot air thereinto, a method comprising carrying out the same procedures in a fluidized granulator. Among them, a method according to spray-coating is preferable because more homogeneous coating can be achieved.

As in the case of the first embodiment, a pigment such as vitamin B₂, β-carotene or crocin pigment can be added to this coating solution for the purpose of coloring the finished enriched rice or enriched barley.

Next, the third embodiment will be explained.

In this embodiment, rice, barley, the emulsifying agent-coated iron salt composition, the vitamins and the hydrogenated oil are the same ones as those in the first embodiment. The polyglycerol fatty acid ester refers to those used together with the hydrogenated oil in the first embodiment. The quantitative relationship of each of the components used is the same as that in the first embodiment.

In the method for producing enriched rice or barley of this embodiment, the rice grains or barley grains can be coated with a mixture comprising an emulsifying agent-coated iron salt composition, vitamins, a hydrogenated oil and a polyglycerol fatty acid ester in the same manner as in the second embodiment.

The enriched rice or barley of the present invention can be used by adding to and mixing with ordinary (i.e. untreated) rice or barley, or the enriched rice or barley can be used alone, when preparation of cooked rice and the like. The ratio of the amount of the enriched rice or barley to ordinary rice or barley is not particularly limited, and the ratio can be arbitrarily set depending upon the degree of enrichment of nutrients for the enriched rice or barley, or the amount intended for enrichment of nutrients to cooked rice or the like. In the case where the enriched rice or barley is added to and mixed with ordinary rice or barley, the enriched rice or barley of the present invention can be added usually in an amount of from 0.01 to 10 parts by weight, preferably from 0.1 to 2 parts by weight based on 100 parts by weight of the untreated rice or barley.

Here, the cooked rice and the like as used herein refers to those prepared by cooking rice and/or barley, such as plain cooked rice, glutinous rice boiled together with azuki beans or cowpea, a rice gruel, a porridge of rice boiled together with vegetables, seafoods and the like, pilaf, fried rice, doria, risotto, rice boiled with barley, and oatmeal.

The present invention will be explained further in detail by means of the following examples, comparative examples and test examples, and the present invention is by no means limited to these examples and the like.

### EXAMPLES

### Example 1

### Preparation of Emulsifying Agent-Coated Iron Salt Composition (1)

An iron solution was prepared by dissolving 130 g of ferric chloride hexahydrate and 3 g of enzymatically decomposed lecithin (SUNLECITHIN L: manufactured by Taiyo Kagaku Co., Ltd.) in 600 g of ion-exchanged water. Also, 200 g of tetrasodium pyrophosphate decahydrate and 17 g of pentaglycerol monomyristate (SUNSOFT A-141E: manufactured by Taiyo Kagaku Co., Ltd.) were dissolved in 5 kg of ion-exchanged water, to prepare a pyrophosphoric acid solution. Next, the above-mentioned iron solution was gradually added to the pyrophosphoric acid solution with stirring, and the pH of the mixture was adjusted to 3.0. The salt-formation of ferric pyrophosphate due to neutralization was terminated, and thereafter the mixture was subjected to a liquid-solid separation by centrifugation (3000G, 5 minutes), to give an emulsifying agent-coated iron salt composition A in a solid phase portion. Subsequently, the resulting composition was dispersed by adding 800 ml of ion-exchanged water, to give 860 ml of a solution of an emulsifying agent-coated iron salt composition A.

The average particle size of this composition as determined by laser diffraction particle size distribution was 0.2 μm, and the iron content was 1.2% by weight.

### Example 2

### Preparation of Emulsifying Agent-Coated Iron Salt Composition (2)

Thirty grams of ferrous fumarate powder, 3 g of enzymatically decomposed lecithin (SUNLECITHIN L: manufactured by Taiyo Kagaku Co., Ltd.), and 17 g of pentaglycerol trioleate (SUNSOFT A-173E: manufactured by Taiyo Kagaku Co., Ltd.) were mixed, and pulverized with Cobol Mill (manufactured by Shinko Pantec Co., Ltd.), to give an emulsifying agent-coated iron salt composition B. The resulting composition was then dispersed by adding 800 ml of ion-exchanged water, to give 810 ml of a solution of an emulsifying agent-coated iron salt composition B.

The average particle size of this composition as determined by laser diffraction particle size distribution was 0.8 μm, and iron content was 1.2% by weight.

### Example 3

### Preparation of Dispersion of Iron Salt and Vitamins (1)

Two grams of potassium iodide, 30 g of vitamin B₁ hydrochloride, 266 g of niacin, 28 mg of vitamin B₁₂, and 3 g of folic acid were mixed, to prepare a vitamin premix.

One-hundred grams of vitamin A palmitate (1,000,000 units/g) and 20 g of a polyglycerol fatty acid ester (SUNSOFT AZ18G: manufactured by Taiyo Kagaku Co., Ltd.) were dissolved in 280 ml of deionized water, to prepare a vitamin A emulsion with a homomixer.

To 167 ml of the solution of an emulsifying agent-coated iron salt composition A obtained in Example 1 were added 6.58 g of the above-mentioned vitamin premix and 16 ml of the vitamin A emulsion, and the mixture was stirred, to give a dispersion C of an iron salt and vitamins.

### Example 4

### Preparation of Dispersion of Iron Salt and Vitamins (2)

The same procedures as in Example 3 were carried out except that 167 ml of the solution of an emulsifying agent-coated iron salt composition B obtained in Example 2 was used as an emulsifying agent-coated iron salt composition, to give a dispersion D of an iron salt and vitamins.

### Example 5

### Preparation of Iron Salt- and Vitamin-Coated Rice (1)

The amount 1.0 kg of polished rice was placed in a coating pan, and an entire amount of the dispersion C of an iron salt and vitamins prepared in Example 3 was sprayed thereto at a rate of 5 ml/minute, while rotating the coating pan, and blowing hot air thereinto, to coat the polished rice. Hot air was continued to be blown for dryness even after the termination of spraying of the dispersion. A portion having fine sizes was removed with an 8-mesh sieve, to give 1.0 kg of iron salt- and vitamin-coated rice E having a water content of 10%.

### Example 6

### Preparation of Iron Salt- and Vitamin-Coated Rice (2)

The amount 1.0 kg of polished rice and an entire amount of the dispersion C of an iron salt and vitamins prepared in Example 3 were placed in a coating pan, and the polished rice was macerated at an initial temperature of 35° C. for 1 hour with rotating the coating pan. Next, the polished rice was steam-boiled with a vapor at about 100° C. for 2 minutes, and thereafter dried with a vapor at about 70° C. A portion having fine sizes was removed with an 8-mesh sieve, to give 1.0 kg of iron salt- and vitamin-coated rice F having a water content of 10%.

### Example 7

### Preparation of Iron Salt- and Vitamin-Coated Rice (3)

The same procedures as in Example 5 were carried out except that the dispersion D of an iron salt and vitamins obtained in Example 4 was used as the dispersion of an iron salt and vitamins, to give 1.0 kg of iron salt- and vitamin-coated rice G having a water content of 10%.

Furthermore, the same procedures as in Example 6 were carried out except that the dispersion D of an iron salt and vitamins obtained in Example 4 was used as a dispersion of an iron salt and vitamins, to give 1.0 kg of iron salt- and vitamin-coated rice H having a water content of 10%.

### Example 8

### Preparation of Iron- and Vitamin-Enriched Rice (1)

Nineteen grams of cottonseed hydrogenated oil, 1 g of hexaglycerol octastearate (SUNFAT PS68: manufactured by Taiyo Kagaku Co., Ltd.) and 0.5 g of hexaglycerol condensed ricinoleate (SUNSOFT 818H: manufactured by Taiyo Kagaku Co., Ltd.) were dissolved and mixed at 80° C. for 10 minutes, to prepare a fat or oil for coating.

Next, 500 g of the iron salt- and vitamin-coated rice E obtained in Example 5 was placed in a coating pan. While rotating the coating pan, a wind of a usual temperature was blown, and the above-mentioned fat or oil for coating was sprayed at a rate of 2.5 g/minute, while keeping the temperature of the above-mentioned fat or oil for coating at 60° C., to give 520 g of enriched rice I of the present invention.

### Example 9

### Preparation of Iron- and Vitamin-Enriched Rice (2)

The same procedures as in Example 8 were carried out except that the iron salt- and vitamin-coated rice F, G or H obtained in Examples 6 and 7 was used as the iron salt- and vitamin-coated rice, to give 520 g each of enriched rice J, K or L of the present invention.

### Comparative Example 1

### Preparation of Comparative Product with Emulsifying Agent-Uncoated Iron Salt (1)

As an iron salt, 10 g of emulsifying agent-uncoated ferric pyrophosphate was weighed so as to have the same amount in terms of an iron content, and dispersed in 160 ml of deionized water. To this dispersion were added 6.58 g of the vitamin premix and 16 ml of the vitamin A emulsion obtained in Example 3, and the mixture was stirred, to prepare a dispersion of an iron salt and vitamins.

The same procedures as in Example 5 were carried out except that the above-mentioned dispersion was used as a dispersion of an iron salt and vitamins, to give iron salt- and vitamin-coated rice having a water content of 10%. Furthermore, the same procedures as in Example 8 were carried out, to give 520 g of comparative product iron salt- and vitamin-enriched rice M.

### Comparative Example 2

### Preparation of Comparative Product with Emulsifying Agent-Uncoated Iron Salt (2)

As an iron salt, 20 g of emulsifying agent-uncoated ferrous sodium citrate was weighed so as to have the same amount in terms of an iron content, and dispersed in 160 ml of deionized water. Thereto were added 6.58 g of the vitamin premix and 16 ml of the vitamin A emulsion obtained in Example 3, and the mixture was stirred, to prepare a dispersion of an iron salt and vitamins.

The same procedures as in Comparative Example 1 were carried out except that the above-mentioned dispersion was used as a dispersion of an iron salt and vitamins, to give 520 g of comparative product iron salt- and vitamin-enriched rice N.

### Comparative Example 3

### Preparation of Comparative Product Coated with Fat or Oil without Containing Polyglycerol Fatty Acid Ester

Nineteen grams of cottonseed hydrogenated oil and 1 g of rice bran wax were dissolved and mixed at 80° C. for 10 minutes, to prepare a fat or oil for coating.

Next, the same procedures as in Example 8 were carried out, except that 500 g of the iron salt- and vitamin-coated rice E obtained in Example 5 was used, and that the above-mentioned fat or oil was used as a fat or oil for spray-coating, to give 520 g of comparative product iron salt- and vitamin-enriched rice O was obtained.

### Test Example 1

### Run-Off Test of Iron and Vitamins Upon Washing Rice

One gram of each kind of iron- and vitamin-enriched rice 1 to 0 of the inventive products and comparative products was respectively mixed with 200 g of polished rice, to give test sample rice. The procedures of adding 250 ml of tap water to each of test sample rice, washing the test sample rice with water so as to rub and loosen at a rate of about 30 rotations per minute, and draining water therefrom were repeated four times. The drained water was collected, and the amounts of iron and vitamins contained in the drained water were determined. The percent loss was obtained by calculating a ratio of the content to that in 1 g of the enriched rice. The results are summarized in Table 1. Here, the amounts of iron and vitamins were determined according to the basis of Standard Methods of Analysis for Hygiene Chemists.

TABLE 1

| Enriched Rice | | | | |
|---|---|---|---|---|
| Used for Test | Percent Loss (%) by Washing Rice | | | |
| Sample Rice | Iron | Vitamin B₁ | Vitamin A | Folic Acid |
| Inventive | 3.9 | 3.1 | 4 | 3.8 |
| Product I | | | | |
| Inventive | 4.5 | 4.3 | 5.2 | 4.8 |
| Product J | | | | |
| Inventive | 8.3 | 9.1 | 8.5 | 9.2 |
| Product K | | | | |
| Inventive | 10.1 | 10.3 | 9.8 | 10.3 |
| Product L | | | | |
| Comparative | 15.8 | 16.5 | 16.2 | 17.1 |
| Product M | | | | |
| Comparative | 20.9 | 20.8 | 19.8 | 20.5 |
| Product N | | | | |
| Comparative | 40.5 | 41.5 | 40.1 | 42.1 |
| Product O | | | | |

It is clear from above results that the inventive products had smaller loss of iron and vitamins by washing rice than the comparative products, and that ferrous fumarate had smaller loss of iron and vitamins less than ferric pyrophosphate.

### Test Example 2

### Test for Residual Vitamins upon Storage

The inventive product I and comparative products M and N were stored at room temperature for one month, and thereafter the amounts of vitamin B₁ and folic acid were determined. The residual ratio was obtained by calculating a ratio of the amount to that before storage. The results are summarized in Table 2.

TABLE 2

| | |
|---|---|
| Enriched Rice | Residual Ratio (%) after One-Month |
| Used for | Storage at Room Temperature |

| Sample | Vitamin B₁ | Folic Acid |
|---|---|---|
| Inventive | 83.5 | 96.2 |
| Product I | | |
| Comparative | 45.8 | 53.2 |
| Product M | | |
| Comparative | 35.9 | 47.4 |
| Product N | | |

It is clear from above results that the case where the inventive product, namely the emulsifying agent-coated iron salt composition was used had higher stability than the cases where an emulsifying agent-uncoated iron salt was used.

Also, in external appearance, the inventive product showed no change in color tone, while both the comparative products were colored brown.

### Test Example 3

### Run-Off Test of Iron by Washing Enriched Rice Coated with Fat or Oil Having Varying Amounts of Polyglycerol Fatty Acid Ester

Each kind of test samples was prepared by varying the amounts of hexaglycerol octastearate and hexaglycerol condensed ricinoleate in Example 8. Each test sample was subjected to the same rice washing test as in Test Example 1, and the percent loss was obtained. The results are summarized in Table 3.

TABLE 3

| | | Amount of | | | Ratio of Polyglycerol |
|---|---|---|---|---|---|
| Amount of | | Hexaglycerol | | | Fatty Acid Ester Based |
| Hexaglycerol | | Condensed | | Percent Loss (%) | on 100 parts by weight |
| Octastearate | | Ricinoleate | | by Washing Rice | of Hydrogenated Oil |
| 0 | g | 0 | g | 20.5 | 0 |
| 3 | g | 1 | g | 6.5 | 21.1 |
| 1 | g | 1 | g | 4.5 | 10.5 |
| 1 | g | 0.5 | g | 3.9 | 7.9 |
| 1.5 | g | 0 | g | 8.3 | 7.9 |

It is clear from the table that one without any addition of a polyglycerol fatty acid ester had a larger run-off of iron by washing rice, and that the combined use of hexaglycerol octastearate with hexaglycerol condensed ricinoleate had a larger run-off of iron than that of hexaglycerol octastearate alone, even though a total amount of the polyglycerol fatty acid ester was large.

### Example 10

### Preparation of Enriched Barley

The same procedures as in Example 5 were carried out except that 1.0 kg of barley was used in place of polished rice, to give iron salt- and vitamin-coated barley having a water content of 10%. Further, the same procedures as in Example 8 were carried out, to give 520 g of enriched barley of the present invention.

### Test Example 4

### Confirmation of Flavor During Rice Cooking

One gram of each enriched rice of the present invention obtained in Example 8 and the enriched barley obtained in Example 10 was respectively mixed with 200 g of polished rice, to give test sample rice. Each of test sample rice was washed in the same manner as in Test Example 1, and thereafter iron- and vitamin-enriched rice was boiled with electric rice cooker. Those with addition of the same amount of rice or barley without enrichment with iron and vitamins were prepared as comparative products. Sensory test was conducted. As a result, there was no difference in flavor therebetween.

### Example 11

### Preparation of Mixture Containing Iron Salt, Hydrogenated Oil and Polyglycerol Fatty Acid Ester (1)

Thirty grams of ferric pyrophosphate, 8 g of hexaglycerol condensed ricinoleate (SUNSOFT 818H; HLB=1: manufactured by Taiyo Kagaku Co., Ltd.), and 62 g of palm hydrogenated oil (melting point: 36° C.) were mixed, and the mixture was pulverized and homogeneously mixed with Cobol Mill (manufactured by Shinko Pantec Co., Ltd.), to give 96 g of a mixture P.

The average particle size of the iron salt as determined by laser diffraction particle size distribution was 0.4 μm.

### Example 12

### Preparation of Mixture Containing Iron Salt, Hydrogenated Oil and Polyglycerol Fatty Acid Ester (2)

Thirty grams of ferrous sulfate heptahydrate, 8 g of hexaglycerol condensed ricinoleate (SUNSOFT 818H; HLB=1: manufactured by Taiyo Kagaku Co., Ltd.), and 62 g of palm hydrogenated oil (melting point: 36° C.) were mixed, and the mixture was pulverized and homogeneously mixed with Cobol Mill (manufactured by Shinko Pantec Co., Ltd.), to give 96 g of a mixture Q.

The average particle size of the iron salt as determined by laser diffraction particle size distribution was 0.4 μm.

### Example 13

### Preparation of Mixture Containing Iron Salt, Hydrogenated Oil and Polyglycerol Fatty Acid Ester (3)

Thirty grams of ferric pyrophosphate, 8 g of hexaglycerol condensed ricinoleate (SUNSOFT 818H; HLB=1: manufactured by Taiyo Kagaku Co., Ltd.), and 62 g of palm hydrogenated oil (melting point: 36° C.) were homogeneously mixed with a homomixer, to give 94 g of a mixture R.

The average particle size of the iron salt as determined by laser diffraction particle size distribution was 3.5 μm.

### Example 14

### Preparation of Mixture Containing Iron Salt, Hydrogenated Oil and Polyglycerol Fatty Acid Ester (4)

Twenty grams of ferric pyrophosphate, 7 g of hexaglycerol condensed ricinoleate (SUNSOFT 818H; HLB=1: manufactured by Taiyo Kagaku Co., Ltd.), 1 g of enzymatically decomposed lecithin (SUNLECITHIN A: manufactured by Taiyo Kagaku Co., Ltd.), 54.2 g of palm hydrogenated oil (melting point: 36° C.), 15 g of the vitamin premix of Example 3, 2.5 g of vitamin A palmitate (1,000,000 units/g), and 0.3 g of casein calcium peptide (CCP: manufactured by Taiyo Kagaku Co., Ltd) were mixed, and the mixture was pulverized and homogeneously mixed with DYNO-MILL (manufactured by Shinmaru Enterprises Corporation), to give 96 g of a mixture S.

The average particle size of the solid content containing the iron salt in the mixture as determined by laser diffraction particle size distribution was 0.3 μm.

### Example 15

### Preparation of Mixture Containing Emulsifying Agent-Coated Iron Salt Composition, Vitamins, Hydrogenated Oil and Polyglycerol Fatty Acid Ester (1)

Ten grams of dextrin was dissolved in 860 ml of the solution of an emulsifying agent-coated iron salt composition A prepared in Example 1, and the solution was spray-dried, to give 90 g of a powder of an emulsifying agent-coated iron salt composition.

The amount 46.5 g of the above-mentioned powder of an emulsifying agent-coated iron salt composition, 6 g of hexaglycerol condensed ricinoleate (SUNSOFT 818H; HLB=1: manufactured by Taiyo Kagaku Co., Ltd.), 0.8 g of enzymatically decomposed lecithin (SUNLECITHIN A: manufactured by Taiyo Kagaku Co., Ltd.), 54.2 g of palm hydrogenated oil (melting point: 36° C.), 15 g of the vitamin premix of Example 3, and 2.5 g of vitamin A palmitate (1,000,000 units/g) were mixed, and the mixture was pulverized and homogeneously mixed with DYNO-MILL (manufactured by Shinmaru Enterprises Corporation), to give 126 g of a mixture T.

The average particle size of the solid content containing the iron salt in the mixture as determined by laser diffraction particle size distribution was 0.3 μm.

### Example 16

### Preparation of Iron-Enriched Rice (1)

Six-hundred grams of polished rice was placed in a coating pan, and coated by spraying 20.6 g of the mixture P obtained in Example 11 to the polished rice at a rate of 2.5 g/minute while rotating the coating pan, blowing wind of an ordinary temperature, and keeping the temperature at 60° C., to give 620 g of enriched rice U of the present invention.

### Example 17

### Preparation of Iron-Enriched Rice (2)

The same procedures as in Example 16 were carried out except that 31 g of the mixture Q obtained in Example 12 was sprayed as a coating liquid, to give 630 g of enriched rice V of the present invention.

### Example 18

### Preparation of Iron-Enriched Rice (3)

The same procedures as in Example 16 were carried out except that 20.6 g of the mixture R obtained in Example 13 was sprayed as a coating liquid, to give 620 g of enriched rice W of the present invention.

### Example 19

### Preparation of Iron-Enriched Rice (4)

The same procedures as in Example 16 were carried out except that 31 g of the mixture S obtained in Example 14 was sprayed as a coating liquid, to give 630 g of enriched rice X of the present invention.

### Example 20

### Preparation of Iron-Enriched Rice (5)

The same procedures as in Example 16 were carried out except that 38 g of the mixture T obtained in Example 15 was sprayed as a coating liquid, to give 635 g of enriched rice Y of the present invention.

### Comparative Example 4

### Preparation of Rice Coated in Two-Step with Iron Salt-Oil

Six-hundred grams of polished rice was placed in a coating pan, and coated by spraying a dispersion prepared by dispersing 6.2 g of ferric pyrophosphate in 200 ml of deionized water at a rate of 5 ml/minute, while rotating the coating pan and blowing hot air therein. Even after finishing spraying the liquid, the hot air was continued to be supplied to dry the rice so as to have a water content of 10%. Thereafter, the air supplied was changed to cool air to cool the rice to 30° C. Next, the air supplied was then changed to an ordinary temperature, and 13.8 g of palm hydrogenated oil (melting point: 36° C.) was sprayed at a rate of 2.5 g/minute, while keeping at a temperature of 60° C., to coat the rice, to give 620 g of a comparative product iron-enriched rice Z.

### Test Example 5

### Run-off Test of Iron by Washing Rice

One gram of each kind of enriched rice U to Z prepared as the inventive products and the comparative products was respectively mixed with 200 g of polished rice, to give test sample rice. The procedures of adding 250 ml of tap water to each of test sample rice, washing the test sample rice with water so as to rub and loosen at a rate of about 30 rotations per minute, and draining water therefrom were repeated four times. The drained water was collected, and the amount of iron contained in the drained water was determined by atomic absorption photometry. The percent loss was obtained by calculating a ratio of the content to that in 1 g of enriched rice. The results are summarized in Table 4.

TABLE 4

| | Percent Loss of Iron |
|---|---|
| Enriched Rice used for | by Washing Rice |
| Test Sample Rice | (%) |
| Inventive Product U | 3.1 |
| Inventive Product V | 9.5 |
| Inventive Product W | 10.3 |
| Inventive Product X | 3.8 |
| Inventive Product Y | 4.2 |
| Comparative Product Z | 27.5 |

It is clear from above results that the inventive products had smaller loss of iron by washing rice than that of the comparative product. Moreover, insoluble ferric pyrophosphate had smaller loss than that of water-soluble ferrous sulfate, and even when the same ferrous pyrophosphate was used, one that was pulverized had smaller loss than one that was unpulverized.

### Example 21

### Preparation of Enriched Barley

The same procedures as in Example 16 were carried out except that 600 g of rice grain barley was used in place of the polished rice, to give 620 g of enriched barley of the present invention.

### Test Example 6

### Confirmation of Flavor During Rice Cooking

Each of 1 g of the enriched rice of the present invention obtained in Example 16 and the enriched barley of the present invention obtained in Example 21 was respectively mixed with 200 g of polished rice, to give test sample rice. Each of the test sample rice was washed in the same manner as in Test Example 5, and thereafter rice enriched with iron was boiled with an electric rice cooker. The same amount of rice or barley without enrichment with iron was added to polished rice, to give comparative products. Sensory test was conducted. As a result, there was no difference in flavor therebetween.

### INDUSTRIAL APPLICABILITY

According to the present invention, enriched rice and the like having very small run-off loss of the enrichment nutrients during washing with water than those of conventional enriched rice and enriched barley can be easily and efficiently provided. Since the flavor of the cooked rice mixed with the enriched rice is not substantially lowered, the enriched rice and the like are very useful for those individuals who take rice and the like as principal foods, so that their industrial applicable values are significant.

1. Iron- and vitamin-enriched rice or barley, characterized in that rice grains or barley grains are coated with an emulsifying agent-coated iron salt composition and vitamins, and further coated with a mixture of a hydrogenated oil and a polyglycerol fatty acid ester.

2. Iron-enriched rice or barley, characterized in that rice grains or barley grains are coated with a mixture comprising an iron salt, a hydrogenated oil and a polyglycerol fatty acid ester.

3. Iron- and vitamin-enriched rice or barley, characterized in that rice grains or barley grains are coated with a mixture comprising an emulsifying agent-coated iron salt composition, vitamins, a hydrogenated oil and a polyglycerol fatty acid ester.

4. The enriched rice or barley according to any one of claims 1 to 3, characterized in that the iron salt has an average particle diameter of 2 μm or less.
